(19) United States
(12) Patent Application Publication
(10) Pub. No.: US 2024/0326005 A1
(43) Pub. Date: Oct. 3, 2024

(54) HYDROGEN GENERATION DEVICE

(71) Applicant: SK INNOVATION CO., LTD., Seoul (KR)

(72) Inventors: Sun Hyuk BAE, Daejeon (KR); Jae Jeong KIM, Daejeon (KR)

(21) Appl. No.: 18/603,207

(22) Filed: Mar. 13, 2024

(30) Foreign Application Priority Data
Mar. 31, 2023 (KR) 10-2023-0042745
Jul. 21, 2023 (KR) 10-2023-0095367

(51) Int. Cl. B01J 19/00; B01J 19/24; F16K 15/02; F23N 1/00

(52) U.S. Cl. CPC B01J 19/0013; B01J 19/2425; F16K 15/026; F23N 1/007; B01J 2219/00157; F23N 2235/16; F23N 2235/24

(57) ABSTRACT

The present disclosure provides a hydrogen generation device. The hydrogen generation device includes: a plurality of cylinders; a combustor disposed in each of the plurality of cylinders to combust a fuel; a distributor configured to deliver the fuel supplied from the fuel supplier to each of the plurality of combustors by distributing the fuel in a uniform quantity, a plurality of reactors disposed in the plurality of cylinders, respectively, to generate hydrogen by a reforming reaction of a feed supplied from a feed supplier while the reactors are heated by a combustion heat transmitted from the combustor, and a fuel meter disposed between the distributor and the combustor to adjust an amount of the fuel delivered from the distributor to the combustor in a fixed quantity.

### CROSS-REFERENCE TO RELATED APPLICATIONS

This application claims priority to Korean Patent Applications Nos. 10-2023-0042745 and 10-2023-0095367 filed on Mar. 31, 2023 and Jul. 21, 2023, respectively, in the Korean Intellectual Property Office (KIPO), the entire disclosures of which are incorporated by reference herein.

### BACKGROUND

### 1. Field

The disclosure of this patent document relates to a hydrogen generation device.

### 2. Description of the Related Art

With the development of science and technology including electrical and electronic technologies, many types of energy sources have been developed and used, and the demand for energy sources has been increased in recent years. As a method for producing energy sources, energy production means using fossil fuels, nuclear power, hydropower, wind power, and the like are used.

However, in order to cope with environmental pollution problems due to exhaust gases generated by burning fossil fuels and an energy crisis due to the depletion of the fossil fuels, efforts to develop non-polluting alternative energy are being made around the world.

Hydrogen fuel is one of the non-polluting alternative energies and has significance in its infinite availability. Examples of hydrogen energy technology may include a fuel cell using hydrogen fuel. The fuel cell is configured to directly produce electricity from hydrogen fuel, and may generate electricity through an electrochemical reaction between a pair of electrodes while supplying a hydrogen gas and air as fuels. These fuel cells may be used as energy sources for electric vehicles, home use, power generation and the like.

Methods for producing hydrogen gas used in the fuel cells may include steam reforming ammonia reforming, partial oxidation, autothermal reforming, and water electrolysis methods. Among them, the steam reforming method is most widely used.

In the case of the steam reforming method, hydrogen may be produced by a reforming reaction of methane and steam in a high temperature state, for example, at 800° C. to 900° C.

In the case of the ammonia reforming method, hydrogen is produced by a reforming reaction of ammonia in a high temperature state, for example, at 800° C. to 900° C.

A conventional hydrogen generator includes: a cylinder, a combustor provided in the cylinder for combusting a fuel, and a reactor provided in the cylinder for producing hydrogen by a reforming reaction of a feed while heated by combustion heat from the combustor. The feed to the reactor may be methane and steam for a steam reforming reaction, or ammonia for an ammonia reforming reaction.

For facilitating the reforming reaction of the feed, equalization of the temperature distribution for each internal region of the cylinder is required. However, as the size (or scale) of the cylinder is increased, it becomes difficult to obtain a uniform temperature for each internal region of the cylinder. Therefore, according to existing technology the size of the cylinder and hydrogen production is limited by the need to equalize the temperature in each internal region of the cylinder.

### SUMMARY

An objective of the present disclosure is to provide a hydrogen generation device in which a uniform quantity of fuel may be supplied to a plurality of combustors provided for each cylinder having a size capable of equalizing the temperature distribution for each internal region, thus to equalize the temperature distribution for each internal region of a plurality of cylinders and increase the hydrogen production volume. Therefore, the hydrogen generation device according to an embodiment of the present disclosure is capable of producing clean energy and promoting environmental friendliness.

Another objective of the present disclosure is to provide a hydrogen generation device which may automatically reduce a flow rate of a specific pipe when the flow rate is concentrated in the specific pipe in a structure where a plurality of fuel supply pipes are provided. Yet another objective of the present disclosure is to provide a hydrogen generation device which may stably produce hydrogen even if the flow rate is unevenly supplied within one fuel supply pipe.

The objectives obtained by the present disclosure are not limited to the above-described objectives, and other objectives may be understood by those skilled in the art from the following description.

According to an aspect of the present invention, there is provided a hydrogen generation device including: a plurality of cylinders; a plurality of combustors disposed in the plurality of cylinders in a one to one correspondence, meaning that each cylinder includes one combustor. The combustor may initiate ignition and may combust a fuel received from a distributor. The hydrogen generation device further includes a distributor configured to deliver the fuel to the combustors. The fuel is supplied to the distributor from a fuel supplier. The distributor is configured to distribute the fuel in a uniform quantity to each one of the combustors. Each cylinder further includes a reactor. Hence, a plurality of reactors are disposed in the plurality of cylinders in a one to one correspondence. Each reactor may generate hydrogen by a reforming reaction of a feed supplied from a feed supplier. In each cylinder, the reactor may be heated by a combustion heat transmitted from the combustor of the cylinder. Each cylinder may further include a fuel meter disposed between the distributor and the combustor of the cylinder, and is configures to adjust an amount of the fuel delivered from the distributor to the combustor in a fixed quantity. The fuel meter may include a connection pipe disposed between the distributor and the combustor. The fuel meter may also have an opening adjuster disposed in the connection pipe for changing the opening degree of the connection pipe depending on the hydraulic pressure of the fuel.

In an embodiment, the opening adjuster may include: a valve seat which extends from an inner peripheral surface of the connection pipe and has a seat hole formed in the inner peripheral surface through which the fuel passes; a valve disc which moves relative to the seat hole depending on the hydraulic pressure of the fuel to change the opening degree of the connection pipe; and a connector which connects the valve disc to the valve seat, the valve seat moving relative to the valve disc

In an embodiment, the connector may include an elastic member configured to move the valve disc in a direction away from the valve seat.

In an embodiment, the valve disc may have at least one disc hole formed therein.

In an embodiment, the valve seat may have a shape in which a plurality of tubes having a relatively smaller diameter toward a flow direction of the fuel are connected with each other.

In an embodiment, the opening adjuster may further include: an auxiliary valve seat which is located upstream from the valve seat based on flow of the fuel, and extends from the inner peripheral surface of the connection pipe to form a seat hole through which the fuel passes; and an auxiliary connector which connects the auxiliary valve seat and the valve disc.

In an embodiment, the connector may include an elastic member configured to generate an elastic force to move the valve disc in a direction away from the valve seat, and the auxiliary connector may include an elastic member configured to generate an elastic force to move the valve disc in a direction closer to the auxiliary valve seat.

In an embodiment, an elastic modulus of the elastic member included in the auxiliary connector may be smaller than an elastic modulus of the elastic member included in the connector.

In an embodiment, the opening adjuster may further include: a guide ring disposed in close contact with an inner wall of the connection pipe to be moved along the inner wall of the connection pipe;

and a guide ring connector which connects the guide ring and the valve disc.

In an embodiment, the hydrogen generation device may further include: an auxiliary distributor configured to deliver the feed supplied from the feed supplier to each of the plurality of reactors by distributing the feed in a uniform quantity between the plurality of reactors; and auxiliary meters disposed in each of the plurality of reactors to adjust an amount of the feed supplied to the reactor in a fixed quantity.

In the hydrogen generation device according to an embodiment of the present disclosure, a uniform quantity of fuel may be supplied to the plurality of combustors disposed in each of the plurality of cylinders having a size capable of equalizing the temperature distribution for each internal region. Thereby, the temperature distribution for each internal region of the plurality of cylinders may be equalized, and the hydrogen production volume may be increased.

In the hydrogen generation device according to an embodiment of the present disclosure, even if an unevenness in a flow rate occurs inside one cylinder, hydrogen may be stably produced by stably controlling the flow rate of the corresponding cylinder.

The effects of the present disclosure are not limited to the above-described effects, and other effects not mentioned above may be clearly understood by those skilled in the art from the following descriptions.

### BRIEF DESCRIPTION OF THE DRAWINGS

The above and other objectives, features and other advantages of the present invention will be more clearly understood from the following detailed description taken in conjunction with the accompanying drawings, in which:

FIG. 1 is a block diagram illustrating the configuration of a hydrogen generation device according to an embodiment of the present disclosure;

FIG. 2 is a perspective view illustrating a distributor of the hydrogen generation device according to an embodiment of the present disclosure;

FIGS. 3 and 4 are cross-sectional views illustrating a first embodiment of a fuel meter of the hydrogen generation device according to an embodiment of the present disclosure;

FIG. 5 is a cross-sectional view schematically illustrating the first embodiment of the fuel meter, a combustor and a reactor of the hydrogen generation device according to an embodiment of the present disclosure;

FIGS. 6 and 7 are cross-sectional views illustrating a second embodiment of the fuel meter of the hydrogen generation device according to an embodiment of the present disclosure;

FIG. 8 is a cross-sectional view schematically illustrating a second embodiment of the fuel meter, a combustor, and a reactor of a hydrogen generation device according to another embodiment of the present disclosure;

FIG. 9 is a cross-sectional view illustrating a state where uneven flow rate occurs within the fuel meter of the hydrogen generation device according to an embodiment of the present disclosure;

FIGS. 10 and 11 are cross-sectional views illustrating a third embodiment of the fuel meter of the hydrogen generation device according to an embodiment of the present disclosure; and

FIG. 12 is a cross-sectional view illustrating a fourth embodiment of the fuel meter of the hydrogen generation device according to an embodiment of the present disclosure.

### DETAILED DESCRIPTION OF THE EMBODIMENTS

The above and other aspects, features, and advantages of the present disclosure will become apparent from the detailed description of the embodiments to be described in detail below in conjunction with the accompanying drawing. In this regard, it should be understood that the present disclosure is not limited to the following embodiments and may be embodied in various different ways, and that the embodiments are given to provide complete disclosure of the present disclosure and to provide a thorough understanding of the present disclosure to a person who has a common knowledge in the technical field to which the present disclosure belongs. present disclosure

Terms used herein are for the purpose of describing particular embodiments only and are not intended to limit the present disclosure thereto. As used herein, singular forms are intended to include the plural forms as well, unless the context clearly indicates otherwise. It will be further understood that the terms “comprises” and/or “comprising” as used herein, do not preclude the presence or addition of one or more elements other than those mentioned. Like reference numerals refer to like elements throughout the present disclosure, and “and/or” includes each mentioned component and all of one or more combinations of the mentioned components. Although a “first,” a “second,” etc. are used to describe various components, these components are of course not limited by these terms. These terms are merely used to distinguish one component from another component. Therefore, a first component may be a technically equivalent component to a second component. present disclosure

Unless otherwise defined, all terms (including technical and scientific terms) used herein have the same meaning as commonly understood by one of ordinary skill in the art to which the present disclosure pertains.

Hereinafter, the present invention will be described in detail with reference to the accompanying drawings.

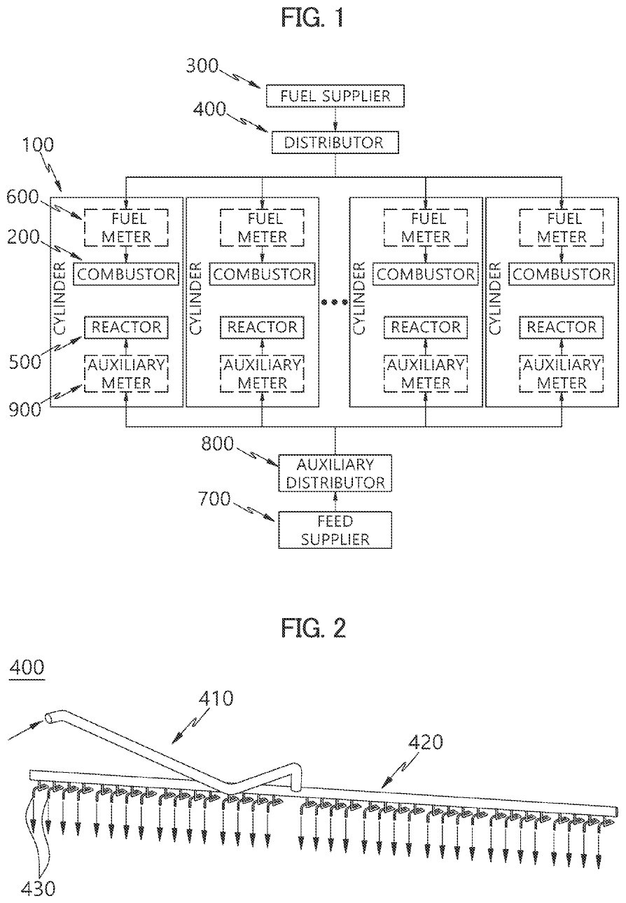

FIG. 1 is a block diagram illustrating the configuration of a hydrogen generation device according to an embodiment of the present disclosure. FIG. 2 is a perspective view illustrating a distributor of the hydrogen generation device according to an embodiment of the present disclosure.

As shown in FIG. 1, the hydrogen generation device according to an embodiment of the present disclosure may include a plurality of cylinders 100, a plurality of combustors 200, a fuel supplier 300, a distributor 400 and a plurality of reactors 500.

The plurality of cylinders 100 may function as a basic body of the hydrogen generation device. Each cylinder 100 may include one combustor 200 and one reactor 500. Each cylinder 100 may have a shape surrounding the combustor 200 and the reactor 500.

Hence, each of the plurality of cylinders 100 may include one of the combustors 200 that is used to ignite and combust the fuel. In operation, each of the combustors 200 may receive a uniform quantity of fuel through the fuel supplier 300 and the distributor 400. The fuel may include hydrogen and nitrogen.

In an embodiment, a burner may be used as the combustor 200. The burner may ignite the fuel to generate combustion heat.

The fuel supplier 300 may supply the fuel to the distributor 400. In an embodiment, the fuel supplier 300 may deliver the fuel stored in a fuel storage tank to the distributor 400 by pumping the fuel with a fuel pump.

The distributor 400 may deliver the fuel supplied from the fuel supplier 300 to each of the plurality of combustors 200 by distributing the fuel in a uniform quantity. Accordingly, as a uniform quantity of fuel is burnt by each of the plurality of combustors 200, the temperature distribution for each internal region between the plurality of cylinders 100 to which the combustion heat from the plurality of combustors 200 is respectively transmitted may be equalized. Thereby, a reforming reaction of the feed may occur in all of the plurality of reactors 500 disposed in each of the plurality of cylinders 100. For example, if the temperature distributions for each internal region between the plurality of cylinders 100 are different, the reference temperature of a specific cylinder 100 may be excessively high while the reference temperature of another specific cylinder 100 may be excessively low, such that the reforming reaction of feed may not occur in all cylinders 100. The reference temperature may be 800° C. to 900° C.

In an embodiment, the feed may include methane and steam for a steam reforming reaction.

In an embodiment, the feed may include ammonia for an ammonia reforming reaction.

As shown in FIG. 2, the distributor 400 may include an inlet pipe 410, a mooring pipe 420, and a plurality of distribution pipes 430.

The fuel supplied from the fuel supplier 300 may flow into the inlet pipe 410. In an embodiment, the inlet pipe 410 may have a curved pipe shape.

The fuel transferred from the inlet pipe 410 may flow in the mooring pipe 420. Referring to FIG. 2, the mooring pipe 420 may be connected to a lower end of the inlet pipe 410. Accordingly, the fuel flowing into the inlet pipe 410 may be transferred to the mooring pipe 420 by a difference in height.

In an embodiment, the mooring pipe 420 may have a horizontal pipe shape. In another embodiment, the mooring pipe 420 may have a vertical pipe shape.

The plurality of distribution pipes 430 may transfer the fuel flowing in the mooring pipe 420 to each of the plurality of combustors 200 by distributing the fuel in a uniform quantity.

In an embodiment, the plurality of distribution pipes 430 may be connected to the lower side of the mooring pipe 420 at a predetermined interval. Accordingly, the fuel flowing in the mooring pipe 420 may be distributed to the plurality of distribution pipes 430 by the gravitational force.

In an embodiment, the plurality of distribution pipes 430 may receive a uniform quantity of fuel flowing in the mooring pipe 420 through a distribution valve, respectively. A solenoid valve may be used as the distribution valve.

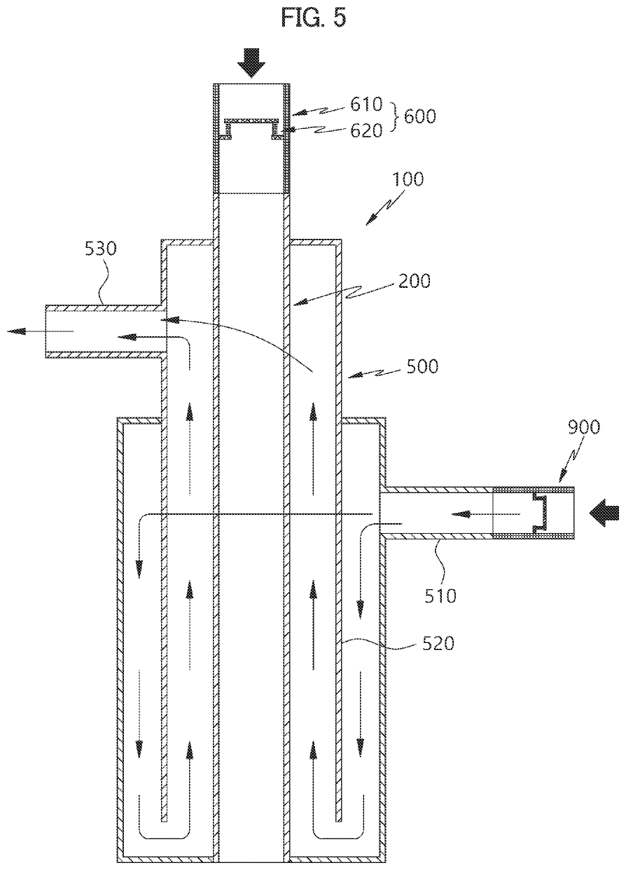

One of the reactor 500 may be disposed in each cylinder 100. Hydrogen may be generated by a reforming reaction of the feed supplied from a feed supplier 700 while the reactors 500 are heated by the combustion heat transmitted from the combustors 200. For example, the reactor 500 may include a feed supply portion 510 (refer to FIG. 5) to which the feed is supplied from an outside, a reaction portion 520 (refer to FIG. 5) in which a reforming reaction of the feed occurs to generate hydrogen, and a discharge portion 530 (refer to FIG. 5) from which the hydrogen generated in the reaction portion 520 is discharged.

Referring to FIG. 5, in an embodiment, the feed supply portion 510 may be connected to the reaction portion 520 and may have a shape extending from one side of the reaction portion 520. In an embodiment, the feed supply portion 510 may have a shape surrounding the reaction portion 520.

Additionally, the feed supplied to the feed supply portion 510 may be preheated by a preheating device. Additionally, the reaction portion 520 may have a shape surrounding the combustor 200. The feed may flow in a zigzag shape inside the feed supply portion 510 and inside the reaction portion 520, and a reaction flow path connecting the feed supply portion 510 and the reaction portion 520 may be formed. Additionally, the discharge portion 530 may be connected to the reaction portion 520 and may have a shape protruding from the other side of the reaction portion 520.

In an embodiment, the reaction portion 520 may be provided with a catalyst. For example, nickel, potassium, potassium oxide, calcium, magnesium oxide, and the like may be used as the catalyst. In an embodiment, the temperature in the reaction portion 520 may be adjusted to 800° C. to 900° C. by the combustion heat transmitted from the combustor 200. In an embodiment, the feed supplier 700 may deliver the feed stored in a feed storage tank to an auxiliary distributor 800 to be described below by pumping it with a feed pump.

Meanwhile, even if the distributor 400 delivers the fuel supplied from the fuel supplier 300 to each of the plurality of combustors 200 by distributing the fuel in a uniform quantity, an amount of fuel introduced into the plurality of combustors 200 may be different depending on a hydraulic pressure of the fuel delivered to the plurality of combustors 200. Accordingly, the hydrogen generation device may further include a fuel meter 600 configured to adjust the amount of fuel delivered to the combustor 200 by the distributor 400 in a fixed quantity.

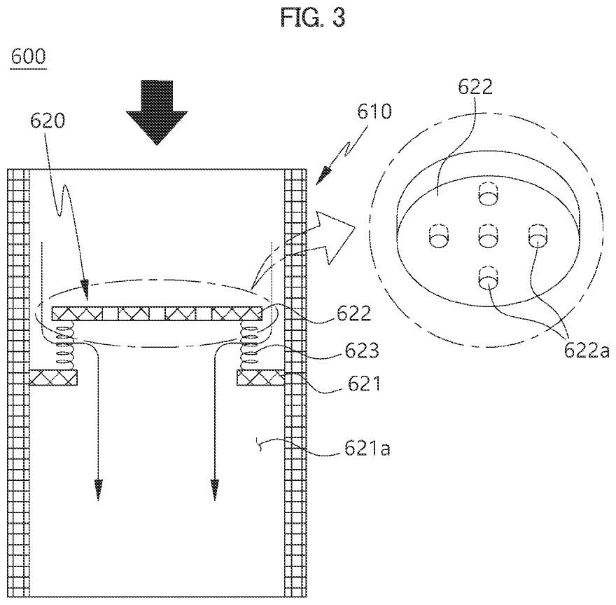

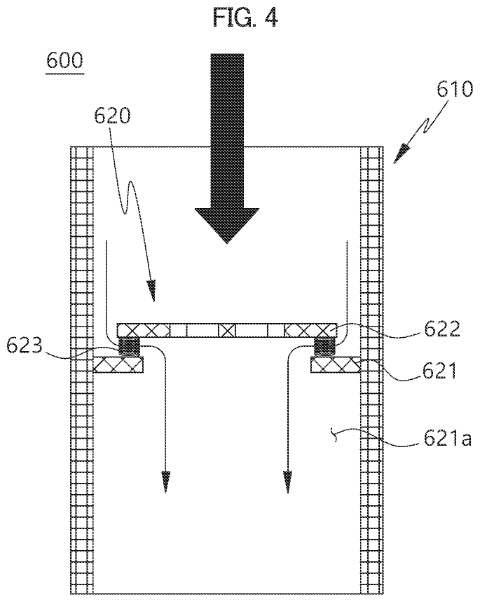

FIGS. 3 and 4 are cross-sectional views illustrating a first embodiment of the fuel meter of the hydrogen generation device according to an embodiment of the present disclosure. FIG. 5 is a cross-sectional view schematically illustrating the first embodiment of the fuel meter, the combustor and the reactor of the hydrogen generation device according to an embodiment of the present disclosure.

As shown in FIGS. 3 to 5, in the first embodiment, the fuel meter 600 may be disposed between the distributor 400 and the combustor 200 to adjust the amount of fuel delivered from the distributor 400 to the combustor 200 in a fixed quantity.

The fuel meter 600 may include a connection pipe 610 and an opening adjuster 620.

The connection pipe 610 may be disposed between the distributor 400 and the combustor 200. In an embodiment, the distributor 400 may be connected to an upper end of the connection pipe 610, and the combustor 200 may be connected to a lower end of the connection pipe 610. Accordingly, the fuel transferred from the distributor 400 may be delivered to the connection pipe 610 and the combustor 200.

The opening adjuster 620 may be disposed in the connection pipe 610 and may change an opening degree of the connection pipe 610 depending on a hydraulic pressure of the fuel flowing into the connection pipe 610. As shown in FIG. 3, the opening adjuster 620 may include a valve seat 621, a valve disc 622 and a connector 623.

The valve seat 621 may extend from an inner peripheral surface of the connection pipe 610. The valve seat 621 may have a seat hole 621a formed therein, through which the fuel passes. In an embodiment, the seat hole 621a may be formed along a central axis of the valve seat 621. In an embodiment, the valve seat 621 may have a ring shape.

The valve disc 622 may be moved in a direction closer to or away from the seat hole 621a depending on the hydraulic pressure of the fuel flowing into the connection pipe 610 to be delivered, thereby changing the opening degree of the connection pipe 610. The movement of the valve disc 622 will be described in detail below.

The connector 623 may connect the valve seat 621 and the valve disc 622. The connector 623 may connect the valve disc 622 to the valve seat 621 to be moved relative thereto. For example, the valve disc 622 may move by the connector 623 while the valve seat 621 is fixed to the inner peripheral surface of the connection pipe 610.

In an embodiment, the connector 623 may include an elastic member for applying an elastic force to the valve disc 622. The elastic member may generate an elastic force to move the valve disc 622 in a direction away from the valve seat 621.

Therefore, if the hydraulic pressure of the fuel delivered to the valve disc 622 is relatively greater than the elastic force of the elastic member, the elastic member is compressed, and the valve disc 622 may be moved in a direction closer to the seat hole 621a. Accordingly, as shown in FIG. 4, the opening degree of the connection pipe 610 may be reduced.

On the other hand, if the hydraulic pressure of the fuel delivered to the valve disc 622 is relatively smaller than the elastic force of the elastic member, the elastic member is elastically restored and expanded, and the valve disc 622 may be moved in a direction away from the seat hole 621a. Accordingly, as shown in FIG. 3, the opening degree of the connection pipe 610 may be increased.

Meanwhile, if the opening of the connection pipe 610 is completely shut off by the valve disc 622, the flow of fuel in the connection pipe 610 may be blocked. In this regard, the valve disc 622 may have at least one disc hole 622a formed therethrough, such that even if the opening of the connection pipe 610 is completely shut off by the valve disc 622, it is possible to prevent the flow of fuel in the connection pipe 610 from being blocked.

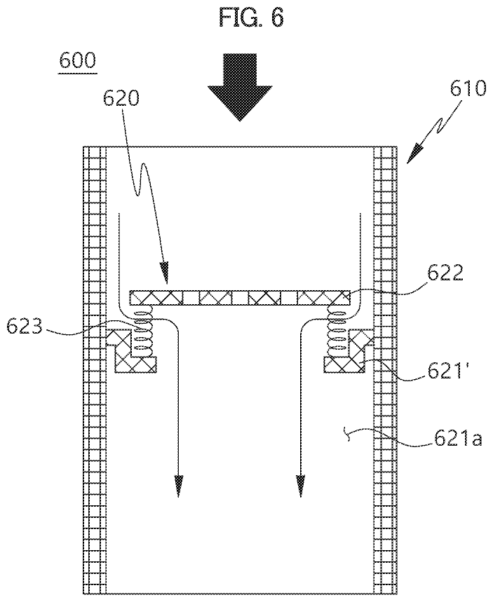

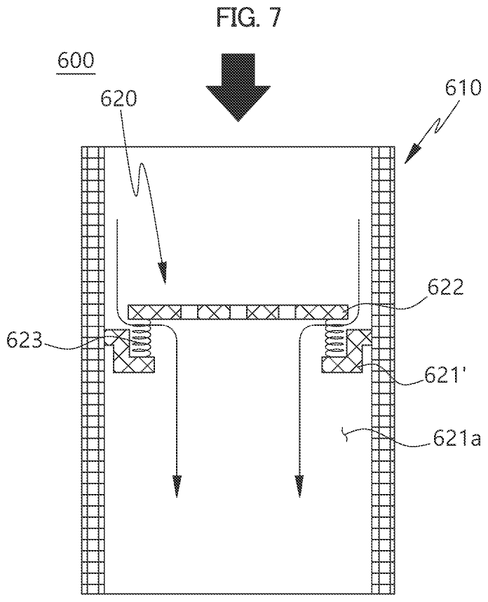

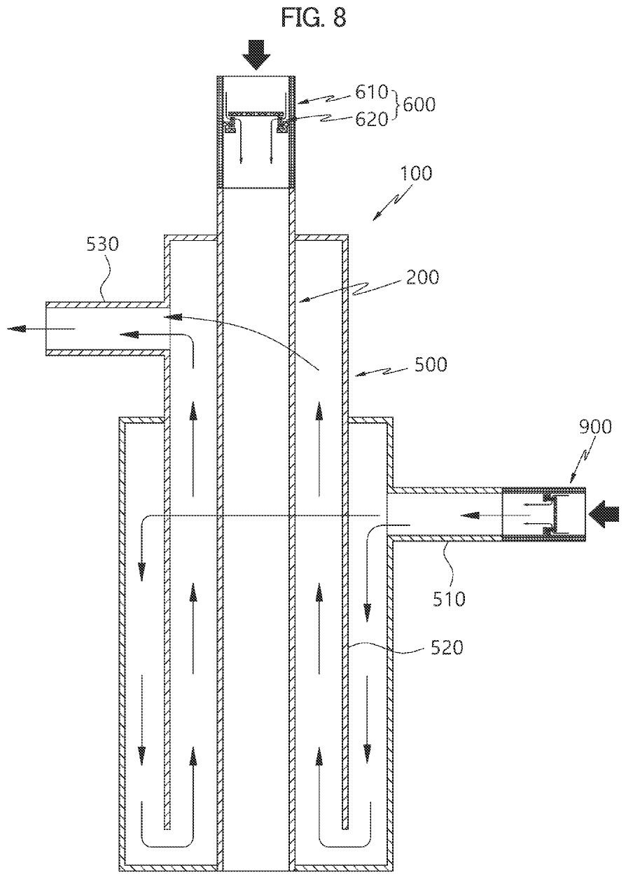

FIGS. 6 and 7 are cross-sectional views illustrating a second embodiment of the fuel meter of the hydrogen generation device according to an embodiment of the present disclosure. FIG. 8 is a cross-sectional view schematically illustrating a second embodiment of the fuel meter, a combustor, and a reactor of a hydrogen generation device according to another embodiment of the present disclosure.

As shown in FIGS. 6 to 8, in the second embodiment of a fuel meter 600, unlike in the first embodiment of the fuel meter 600, a valve seat 621′ may have a shape in which a plurality of tubes having a relatively smaller diameter toward a flow direction of the fuel in the connection pipe 610 are connected with each other. For example, the valve seat 621′ may have a cross-section formed in a multistep shape. The cross-section may be along a perpendicular direction to the flow direction of the fuel.

In the second embodiment, the diameter of the valve disc 622 may correspond to the diameter of a tube having the smallest diameter among the plurality of tubes.

Accordingly, in the second embodiment of the fuel meter 600, a moving distance of the valve disc 622 may be relatively greater than the moving distance of the valve disc 622 in the first embodiment of the fuel meter 600.

The hydrogen generation device according to an embodiment of the present disclosure may further include an auxiliary distributor 800 and auxiliary meters 900.

The auxiliary distributor 800 may deliver the feed supplied from the feed supplier 700 to each of the plurality of reactors 500 by distributing the feed in a uniform quantity. For example, the auxiliary distributor 800 may deliver the feed supplied from the feed supplier 700 to the feed supply portion 510 of the reactor 500.

In an embodiment, the auxiliary distributor 800 may have substantially the same structure as the distributor 400.

The auxiliary meters 900 may be disposed in each of the reactors 500 to adjust an amount of feed supplied to the reactor 500 in a fixed quantity. In an embodiment, the auxiliary meter 900 may be disposed in the feed supply portion 510 of the reactor 500.

In an embodiment, the auxiliary meter 900 may have substantially the same structure as the first embodiment of the fuel meter 600.

In an embodiment, the auxiliary meter 900 may have substantially the same structure as the second embodiment of the fuel meter 600.

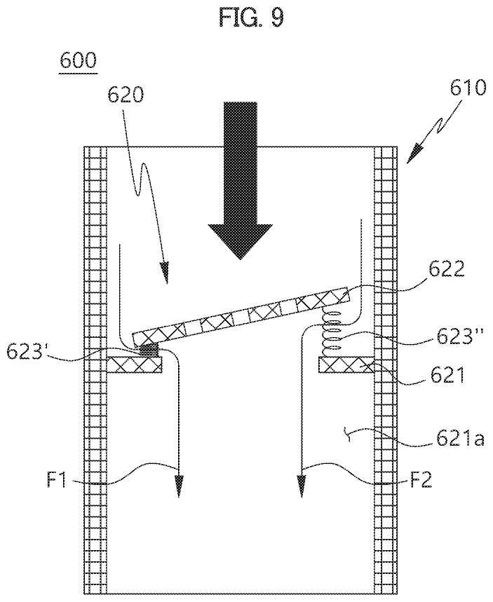

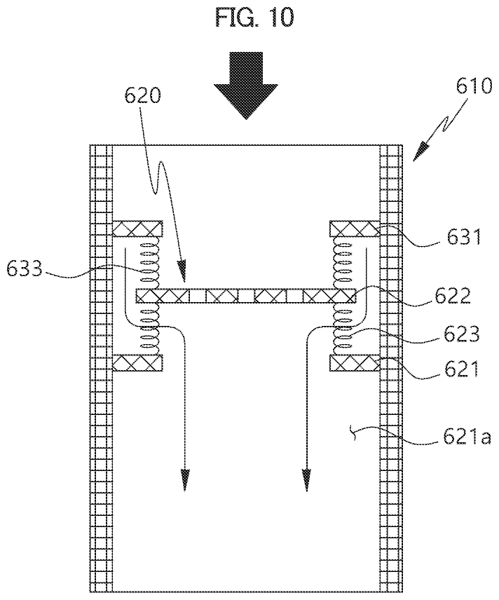

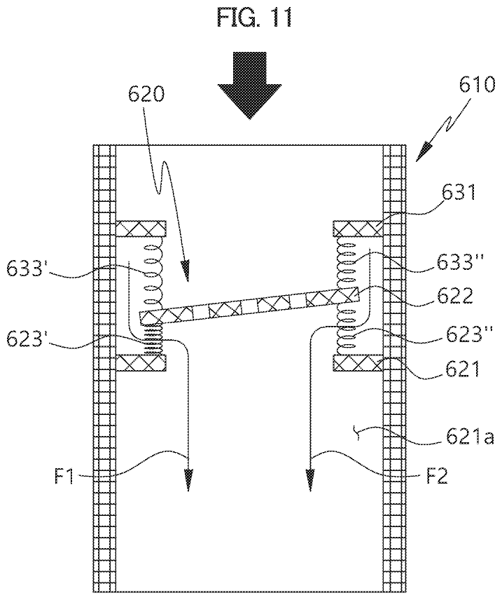

FIG. 9 is a cross-sectional view illustrating a state where uneven flow rate occurs within the fuel meter of the hydrogen generation device according to an embodiment of the present disclosure. FIGS. 10 and 11 are cross-sectional views illustrating a third embodiment of the fuel meter of the hydrogen generation device according to an embodiment of the present disclosure.

Referring to FIG. 9, an unevenness in a flow rate may occur within the fuel meter 600 of the hydrogen generation device according to an embodiment of the present disclosure. For example, as shown in FIG. 9, non-uniformity between a first flow rate F1 and a second flow rate F2 may occur in the fuel meter 600.

In this case, magnitudes of forces applied to a first connector 623′ and a second connector 623″ which connect the valve seat 621 and the valve disc 622 on opposite sides may be different from each other, and compression degrees of the respective connectors may be different from each other. Accordingly, the valve disc 622 may be tilted, and the opening adjuster 620 may not temporarily adjust the flow rate.

In this regard, the opening adjuster 620 included in the hydrogen generation device according to an embodiment of the present disclosure may further include an auxiliary valve seat 631 and an auxiliary connector 633. Accordingly, tilting of the valve disc 622 due to the different flow rates may be prevented.

As shown in FIG. 10, an auxiliary valve seat 631 may be located upstream from the valve seat 621 based on flow of the fuel, and may be fixed to an inner wall of the connection pipe 610. One end of each of the plurality of auxiliary connectors 633 may be connected to the auxiliary valve seat 631, and the other end thereof may be connected to the valve disc 622. The auxiliary connector 633 may be connected to one side of both sides of the valve disc 622, which is a side opposite to the side to which the connector 623 is connected. The auxiliary connector 623 may include an elastic member which generates an elastic force to move the valve disc 622 in a direction closer to the auxiliary valve seat 631.

In an embodiment, similar to the valve seat 621, the auxiliary valve seat 631 may extend from the inner peripheral surface of the connection pipe 610. The auxiliary valve seat 631 may have a seat hole formed therein, through which the fuel passes. In an embodiment, the auxiliary valve seat 631 may have a ring shape.

Referring to FIG. 11, if an unevenness between the first flow rate F1 and the second flow rate F2 occurs in the fuel meter, the magnitudes of the forces applied to the first connector 623′ and the second connector 623″ may be different from each other, and the first connector 623′ may be compressed to a greater extent than the second connector 623″.

A force applied to the first auxiliary connector 633′ may be greater than a force applied to the second auxiliary connector 633″. Accordingly, the first auxiliary connector 633′ may generate a relatively greater elastic force than the second auxiliary connector 633″. The elastic forces generated by the first auxiliary connector 633′ and the second auxiliary connector 633″ may be elastic forces to move the valve disc 622 in a direction closer to the auxiliary valve seat 631.

The first auxiliary connector 633′ may provide an elastic force in a direction opposite to a force applied to the first connector 623′, and the second auxiliary connector 633″ may provide an elastic force in a direction opposite to a force applied to the second connector 623″. The first auxiliary connector 633′ generates a relatively greater elastic force than the second auxiliary connector 633″, and thus the imbalance in the forces applied to the first connector 623′ and the second connector 623″ may be alleviated. Accordingly, despite the difference in the flow rate within the fuel meter 600, a tilting degree of the valve disc 622 may be greatly reduced.

In an embodiment, an elastic modulus of the elastic member included in the auxiliary connector 633 may be smaller than an elastic modulus of the elastic member included in the connector 623. Accordingly, the auxiliary connector 633 may be used to prevent the valve disc 622 from being tilted.

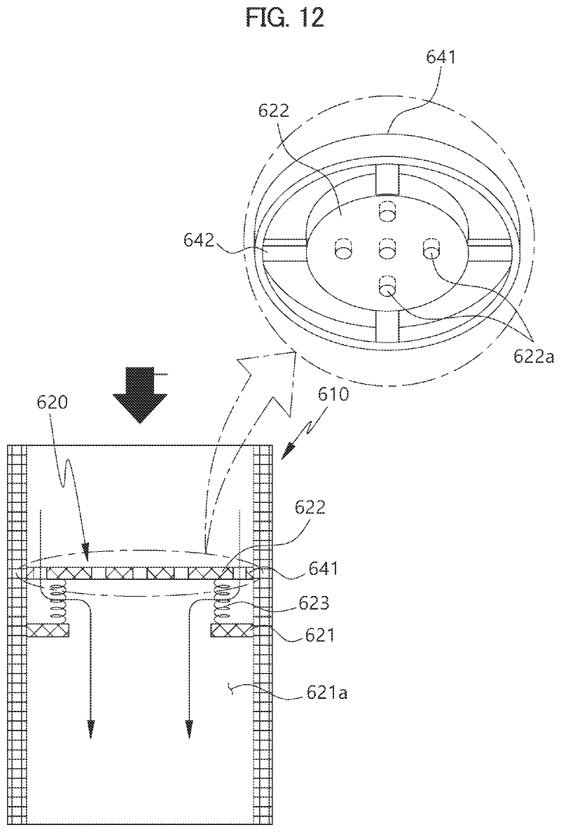

FIG. 12 is a cross-sectional view illustrating a fourth embodiment of the fuel meter of the hydrogen generation device according to an embodiment of the present disclosure.

Referring to FIG. 12, the opening adjuster 620 included in the hydrogen generation device according to an embodiment of the present disclosure may further include a guide ring 641 and a plurality of guide ring connectors 642.

The guide ring 641 is disposed in close contact with the inner wall of the connection pipe 610 to be moved along the inner wall of the connection pipe 610 in an up and down direction, i.e., a vertical direction. The vertical direction refers to a direction parallel to a direction in which the connection pipe 610 extends, and an upstream direction in terms of the fuel flow is upward movement, and a downstream direction is downward movement.

In an embodiment, the guide ring 641 may have a ring shape.

The guide ring connectors 642 may connect the guide ring 641 and the valve disc 622. Accordingly, a vertical movement of the guide ring 641 may occur together with a vertical movement of the valve disc 622.

The guide ring 641 may have a minimum thickness so as not to interfere with the flow of the fuel. The guide ring 641 may prevent the valve disc 622 from tilting within the fuel meter 600, which may be caused by an uneven flow rate occurring within the fuel meter 600. For example, the guide ring 641 moves in the vertical direction in close contact with the inner wall of the connection pipe 610, so that tilting thereof may be prevented even when forces of different magnitudes are applied to each region of the guide ring 641. Accordingly, even if uneven flow occurs within the fuel meter 600, the guide ring 641 may only move in the vertical direction without being tilted. Therefore, even if unevenness in the flow rate occurs within the fuel meter 600, the valve disc 622 may only move in the vertical direction by the guide ring 641.

The guide ring 641 and the guide ring connectors 642 may be utilized together with the auxiliary valve seat 631 and auxiliary connector 633 shown in FIG. 10.

In the hydrogen generation device according to an embodiment of the present disclosure, a uniform quantity of fuel may be supplied to the plurality of combustors 200 provided in each of the plurality of cylinders 100 having a size capable of equalizing the temperature distribution for each internal region. Thereby, the temperature distribution for each internal region of the plurality of cylinders 100 may be equalized, and the hydrogen production volume may be increased.

In the hydrogen generation device according to an embodiment of the present disclosure, even if an unevenness in the flow rate occurs inside one cylinder, hydrogen may be stably produced by stably controlling the flow rate of the corresponding cylinder.

As such, embodiments of the present disclosure have been described with reference to the accompanying drawings, but it should be understood by those skilled in the art that the present disclosure may be implemented in other specific embodiments without changing the technical idea and essential characteristics of the disclosure. Accordingly, it should be understood that the above-described embodiments are only intended to illustrate the present disclosure and are not intended to limit the scope thereof in all aspects.

What is claimed is:

1. A hydrogen generation device comprising:
a plurality of cylinders;
a plurality of combustors disposed in the plurality of cylinders in a one to one correspondence, each combustor initiating and combusting fuel fed to its corresponding cylinder,
a distributor configured to deliver fuel supplied from a fuel supplier to each of the plurality of combustors by distributing the fuel equally between the plurality of the combustors;
a plurality of reactors disposed in the plurality of cylinders in a one to one correspondence, each reactor generating hydrogen by a reforming reaction of a feed supplied from a feed supplier while the reactors are heated by a combustion heat transmitted from the combustor, and
a fuel meter disposed between the distributor and each of the combustors for adjusting an amount of the fuel delivered from the distributor to each of the combustors in a fixed quantity,
wherein the fuel meter comprises:
a connection pipe disposed between the distributor and the combustor, and
an opening adjuster disposed in the connection pipe to change an opening degree of the connection pipe depending on a hydraulic pressure of the fuel.

2. The hydrogen generation device according to claim 1, wherein the opening adjuster comprises:
a valve seat extending from an inner peripheral surface of the connection pipe and having a seat hole formed in the valve seat through which the fuel passes;
a valve disc which moves relative to the seat hole depending on the hydraulic pressure of the fuel to change the opening degree of the connection pipe; and
a connector which connects the valve disc to the valve seat, the valve disc moving relative to the valve seat.

3. The hydrogen generation device according to claim 2, wherein the connector comprises an elastic member configured to move the valve disc in a direction away from the valve seat.

4. The hydrogen generation device according to claim 3, wherein the valve disc has at least one disc hole formed therein.

5. The hydrogen generation device according to claim 2, wherein the valve seat has a shape in which a plurality of tubes having a relatively smaller diameter toward a flow direction of the fuel are connected with each other.

6. The hydrogen generation device according to claim 2, wherein the opening adjuster further comprises:
an auxiliary valve seat located upstream from the valve seat based on flow of the fuel, and extending from the inner peripheral surface of the connection pipe to form a seat hole through which the fuel passes; and
an auxiliary connector which connects the auxiliary valve seat and the valve disc.

7. The hydrogen generation device according to claim 6, wherein the connector comprises an elastic member configured to generate an elastic force to move the valve disc in a direction away from the valve seat, and
the auxiliary connector comprises an elastic member configured to generate an elastic force to move the valve disc in a direction closer to the auxiliary valve seat.

8. The hydrogen generation device according to claim 7, wherein an elastic modulus of the elastic member included in the auxiliary connector is smaller than an elastic modulus of the elastic member included in the connector.

9. The hydrogen generation device according to claim 2, wherein the opening adjuster further comprises:
a guide ring disposed in contact with an inner wall of the connection pipe to be moved along the inner wall of the connection pipe; and
a guide ring connector which connects the guide ring and the valve disc.

10. The hydrogen generation device according to claim 1, further comprising:
an auxiliary distributor configured to deliver the feed supplied from the feed supplier to each of the plurality of reactors by distributing the feed in a uniform quantity between the plurality of reactors; and
an auxiliary meter disposed in the reactors to adjust an amount of the feed supplied to the reactor in a fixed quantity.

11. A hydrogen generation device comprising:
a fuel supplier,
a distributor receiving fuel from a fuel supplier and delivering the fuel in a uniform amount to each one of a plurality of cylinders;
the plurality of cylinders;
a feed supplier, and
an auxiliary distributor,
wherein each cylinder among the plurality of the cylinders includes:
a fuel meter, a combustor, a reactor, and an auxiliary feed meter,
wherein the fuel meter is disposed between the distributor and the combustor for adjusting an amount of the fuel delivered from the distributor to the combustor in a fixed amount,
wherein the combustor is combusting the fuel,
wherein the reactor is generating hydrogen by a reforming reaction of a feed supplied from the feed supplier, and
wherein the fuel meter comprises:
a connection pipe disposed between the distributor and the combustor, and
an opening adjuster disposed in the connection pipe to change an opening degree of the connection pipe depending on a hydraulic pressure of the fuel.
